(19) United States
(12) Patent Application Publication
(10) Pub. No.: US 2023/0194888 A1
(43) Pub. Date: Jun. 22, 2023

(54) OPTICAL DEVICE FOR VEHICLE

(71) Applicant: SL Corporation, Daegu (KR)

(72) Inventors: Chang Ho RYU, Gyeongsan-si (KR); Jong Woon KIM, Gyeongsan-si (KR); Hyeong Do KIM, Gyeongsan-si, (KR)

(21) Appl. No.: 18/167,213

(22) Filed: Feb. 10, 2023

Related U.S. Application Data
(63) Continuation of application No. PCT/KR2021/009421, filed on Jul. 21, 2021.

(30) Foreign Application Priority Data
Sep. 3, 2020 (KR) 10-2020-0112458

(51) Int. Cl. G02B 27/64; B60K 35/00; G02B 27/09; G02B 27/00

(52) U.S. Cl. CPC G02B 27/646; B60K 35/00; G02B 27/095; G02B 27/0068; B60K 2370/48

(57) ABSTRACT

An optical device for a vehicle includes an optical sensor module for detecting light that propagates through a light transmitting member; and a correction optical system that includes at least one optical member for allowing the light that propagates between the light transmitting member and the optical sensor module to be refracted in a direction different from a direction refracted by the light transmitting member.

### CROSS-REFERENCE TO RELATED APPLICATIONS

The present application is a Continuation of International Application No. PCT/KR2021/009421 filed on Jul. 21, 2021, which claimed priority from Korean Application No. 10-2020-0112458 filed on Sep. 3, 2020. The aforementioned applications are incorporated herein by reference in their entireties.

### TECHNICAL FIELD

The present disclosure relates to an optical device for a vehicle. More specifically, the present disclosure relates to an optical device for a vehicle that can prevent inaccurate sensing that may result from a change in a propagation direction of light coming from the exterior of the vehicle.

### RELATED ART

In general, a vehicle provides convenience of mobility and efficiency of time. However, due to carelessness of a driver, there is a possibility of causing great damage to the driver as well as to those around him/her. For this reason, various sensors such as a camera or a lidar for detecting risk factors around the vehicle are disposed in the vehicle.

An optical sensor such as a camera or a lidar receives light reflected from an object around the vehicle and generates an image of a surrounding around the vehicle based on the received light, or detects a position of or a distance to the object around the vehicle, based on the received light. Depending on the detection result, a dangerous situation is notified to the driver so that the driver may quickly cope with the dangerous situation.

In this regard, there is a possibility that a propagation direction of the light may change before the light coming from outside of the vehicle is received by the optical sensor, depending on an installation location of the optical sensor. When the propagation direction of the light is changed, the accuracy of the detection result by the optical sensor may be decreased. Therefore, a scheme capable of correcting the change of the propagation direction of the light occurring before the light coming from the exterior of the vehicle is received by the optical sensor is required.

### SUMMARY

Aspects of the present disclosure provide an optical device for a vehicle capable of correcting a propagation direction of light when the propagation direction of light is changed before the light coming from the exterior of the vehicle is received by an optical sensor. However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, an optical device for a vehicle may include an optical sensor module for detecting light that propagates through a light-transmissive member and toward the optical sensor module; and a correction optical system that includes at least one optical member to refract the light that propagates between the light-transmissive member and the optical sensor module in a direction different from a direction in which the light-transmissive member refracts the light.

The optical sensor module may include at least one of a camera or a lidar.

The at least one optical member may be formed in an asymmetric configuration in at least one direction around an optical axis of the optical sensor module.

One of the correction optical system or the light-transmissive member may allow light that transmits therethrough to converge, while the other thereof may allow light that transmits therethrough to diverge.

The correction optical system may refract the light in a direction opposite to the direction in which the light-transmissive member refracts the light.

In response to the light-transmissive member being deformed due to an ambient temperature change such that a refractive power of the light-transmissive member is changed, the correction optical system may be configured to compensate for the changed refractive power of the light-transmissive member.

In some embodiments, the correction optical system may be configured such that the at least one optical member may be deformed based on the ambient temperature change so as to compensate for the changed refractive power of the light-transmissive member.

In some other embodiment, the correction optical system may be configured such that a position of the at least one optical member may be adjusted based on the ambient temperature change so as to compensate for the changed refractive power of the light-transmissive member. The position of the at least one optical member may be adjusted linearly, rotationally, or by any combination thereof.

In some other embodiments, the correction optical system may be configured such that the at least one optical member is fixed to a fixing member that is deformable based on the ambient temperature change, and in response to the fixing member being deformed, a position of the at least one optical member may be adjusted to compensate for the changed refractive power of the light-transmissive member.

The optical sensor module may further include a light-emitting module for emitting light toward the light-transmissive member, and the correction optical system may refract the light emitted from the light-emitting module in a direction different from a direction in which the light-transmissive member refracts the light emitted from the light-emitting module.

The correction optical system may refract the light emitted from the light-emitting module in a direction opposite to the direction in which the light-transmissive member refracts the light emitted from the light-emitting module.

The correction optical system may include a first area for refracting light that transmits through the light-transmissive member and propagates toward the optical sensor module, and a second area for refracting the light that is emitted from the light-emitting module and propagates toward the light-transmissive member.

The at least one optical member may include at least one of a lens, a mirror, or a prism.

The light-transmissive member and the correction optical system may have opposite chromatic aberration patterns.

The correction optical system may have a transmittance of at least 50% for a light beam of a wavelength required to be detected by the optical sensor module among light beams incident thereto from an exterior of the vehicle and/or a transmittance of at least 50% for a light beam of a wavelength required to be irradiated to the exterior of the vehicle among light beams emitted from the optical sensor module.

Other details of the present disclosure are included in the detailed descriptions and drawings.

The optical device for the vehicle according to the present disclosure may present one or more of the following effects. When the propagation direction of the light is changed before the light coming from the exterior of the vehicle is sensed by the optical sensor module, the propagation direction may be corrected so that accurate sensing may be achieved. Further, when the light emitted from the optical sensor module senses the light reflected from the object around the vehicle, the change in the propagation direction of the light emitted from the optical sensor module may be corrected. However, the effects of the embodiments are not restricted to those set forth herein. The above and other effects of the disclosure will become more apparent to one of ordinary skill in the art to which the disclosure pertains.

### BRIEF DESCRIPTION OF THE DRAWINGS

FIG. 1 is a schematic diagram showing a configuration of an optical device for a vehicle according to an embodiment of the present disclosure;

FIG. 2 is a schematic diagram showing a propagation direction of light received by an optical device for a vehicle according to an embodiment of the present disclosure;

FIG. 3 is a schematic diagram showing an optical sensor module and a correction optical system according to an embodiment of the present disclosure;

FIG. 4 and FIG. 5 are schematic diagrams showing a light-transmissive member deformed by an ambient temperature according to an embodiment of the present disclosure;

FIGS. 6 to 10 are schematic diagrams showing correction optical systems whose position is adjusted according to an embodiment of the present disclosure;

FIG. 11 is a schematic diagram showing a configuration of an optical device for a vehicle according to another embodiment of the present disclosure; and

FIG. 12 is a schematic diagram showing a propagation direction of light emitted from an optical device for a vehicle according to another embodiment of the present disclosure.

### DETAILED DESCRIPTION

Advantages and features of the present disclosure, and methods for achieving the same will become clear with reference to embodiments as described later in detail in conjunction with the accompanying drawings. However, the present disclosure is not limited to the embodiments as disclosed below and may be implemented in various different forms. These embodiments are provided to make the disclosure of the present disclosure complete and to completely inform those skilled in the art of the scope of the present disclosure. The scope of the present disclosure is defined only by the scope of the claims. The same reference numbers refer to the same components throughout the present disclosure.

Thus, in some embodiments, well-known process steps, well-known structures and well-known techniques are not described in detail in order to avoid ambiguous interpretation of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items.

Further, the embodiments as described in the present disclosure will be described with reference to cross-sectional views and/or schematic diagrams as ideal illustrative diagrams of the present disclosure. Accordingly, a form of each of the illustrative drawings may be modified due to manufacturing techniques and/or tolerances. Therefore, the embodiments of the present disclosure are not limited to specific forms as shown, and may include changes in the form occurring according to a manufacturing process. In addition, in each of the drawings as shown in the present disclosure, a size of each component may be somewhat enlarged or reduced in consideration of convenience of the illustration. Like reference numbers designate like elements throughout the present disclosure.

Hereinafter, the present disclosure will be described with reference to the drawings for illustrating an optical device for a vehicle according to embodiments of the present disclosure.

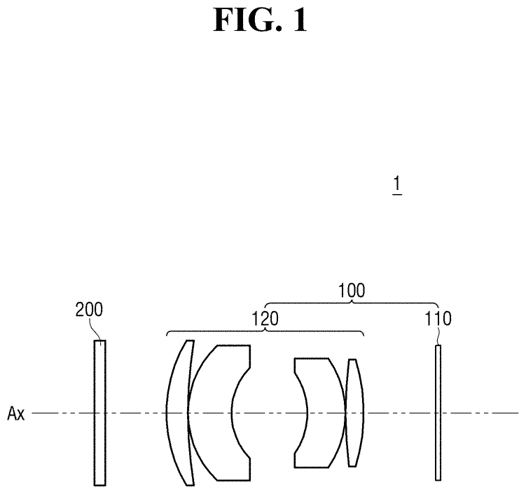

FIG. 1 is a schematic diagram showing a configuration of an optical device for a vehicle according to an embodiment of the present disclosure. Referring to FIG. 1, an optical device 1 for a vehicle according to an embodiment of the present disclosure may include an optical sensor module 100 and a correction optical system 200.

In an embodiment of the present disclosure, the optical device 1 for a vehicle may receive light reflected from an object around the vehicle and may convert the received light into image data or detect a position of or a distance to the object, based on the received light. Sunlight or light emitted from the optical device 1 for the vehicle according to the present disclosure may be reflected from the object around the vehicle and may be received thereby.

The optical sensor module 100 may include a light-receiving sensor 110 and at least one optical element 120.

The light-receiving sensor 110 may be embodied as an image sensor such as a Charge Coupled Device (CCD) image sensor, a Complementary Metal Oxide Semiconductor (CMOS) image sensor, a photo diode (PD) image sensor, and the like. The at least one optical element 120 may allow the light coming from an outside of the vehicle to propagate along an appropriate propagation direction to enable detection thereof by the light-receiving sensor 110.

In an embodiment of the present disclosure, a case in which a plurality of lenses are arranged along an optical axis Ax of the optical device 100 as the at least one optical element 120 is described by way of example. However, the present disclosure is not limited thereto, and the at least one optical element 120 may include various optical elements capable of adjusting the propagation direction of light, such as a lens, a mirror, a prism, and the like.

In this regard, the optical sensor module 100 is generally designed under an assumption that the light coming from the exterior of the vehicle propagates in parallel to the optical axis Ax of the optical device 1. Thus, when the propagation direction of the light is changed due to an external factor before the light is received by the optical sensor module 100, the light may be detected inaccurately.

In an embodiment of the present disclosure, when the propagation direction of the light is changed before the light is received by the optical sensor module 100, the propagation direction of the light may be corrected via the correction optical system 200 so that the optical sensor module 100 more accurately detects the light. In other words, when the optical sensor module 100 is located inside the vehicle or inside an exterior lamp, the light coming from the exterior of the vehicle may be refracted by the vehicle's windshield or a cover lens of the exterior lamp. In such case, the light may not be detected accurately by the optical sensor module 100. In an embodiment of the present disclosure, even if the propagation direction of light is changed by the windshield or the cover lens, the propagation direction of the light may be corrected via the correction optical system 200 so that the optical sensor module 100 may detect the light more accurately.

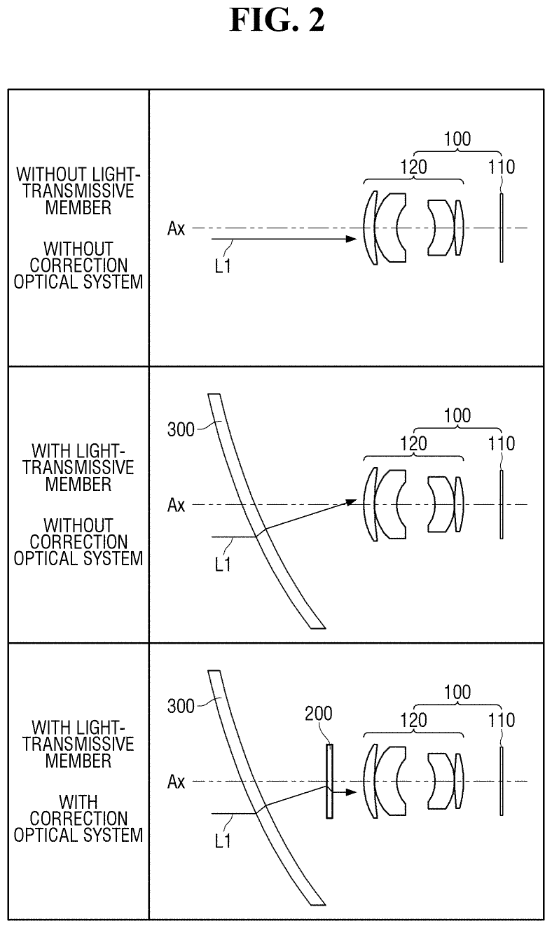

FIG. 2 shows schematic diagrams for propagation directions of light received by an optical device for a vehicle according to an embodiment of the present disclosure. Referring to FIG. 2, based on an installation position of the optical sensor module 100 according to an embodiment of the present disclosure, a light-transmissive member 300 such as the windshield or the cover lens as described above may be installed in front of the optical sensor module 100, such that there is a possibility that the light coming from the exterior of the vehicle may be refracted thereby. When the correction optical system 200 does not correct the propagation direction of the light, the incoming light may be inaccurately detected by the optical sensor module 100.

In other words, when the light-transmissive member 300 that refracts the light coming from the exterior of the vehicle is not present in front of the optical sensor module 100, the light L1 coming from the exterior of the vehicle propagates parallel to the optical axis Ax of the optical sensor module 100 and is received thereby, as shown in the first row of FIG. 2. When the light-transmissive member 300 is present in front of the optical sensor module 100, however, the light L1 entering from the exterior of the vehicle may be refracted and then proceed, as shown in the second row of FIG. 2. In such case, there is a possibility that the light may be detected inaccurately by the optical sensor module 100.

In an embodiment of the present disclosure, therefore, the correction optical system 200 may be disposed between the optical sensor module 100 and the light-transmissive member 300, such that the light L1 entering from the exterior of the vehicle may be refracted in a different direction from a direction in which the light is refracted by the light-transmissive member 300, as shown in the third row of FIG. 2. Thus, similar to a case where the light-transmissive member 300 is not present, the light may proceed toward the optical sensor module 100 in a direction parallel to the optical axis Ax of the optical sensor module 100 such that the light is received thereby.

In an embodiment of the present disclosure, a case in which the correction optical system 200 refracts the light in a direction opposite to the direction in which the light is refracted by the light-transmissive member 300 is described by way of example. However, this is only an example for helping understanding of the present disclosure, and the present disclosure is not limited thereto. The correction optical system 200 may refract the light coming from the exterior of the vehicle in the same side in which the light is refracted by the light-transmissive member 300 such that a refraction angle by which the correction optical system 200 refracts the light may be adjusted based on a position of the optical sensor module 100 and/or a shape of the light-transmissive member 300, such that the light may propagate in a parallel direction with the optical axis Ax of the optical sensor module 100.

Further, in an embodiment of the present disclosure, a case in which the correction optical system 200 is configured as a single lens and is provided separately from the optical sensor module 100 will be described by way of example. However, the present disclosure is not limited thereto, and the correction optical system 200 may include not only the lens but also at least one or more optical members such as a mirror and a prism capable of correcting the propagation direction of light. In some embodiments, the correction optical system 200 may be integrally formed with the optical sensor module 100 or the light-transmissive member 300.

The expression that the correction optical system 200 is integrally formed with the optical sensor module 100 or the light-transmissive member 300 may mean not only that they may be manufactured integrally with each other, but also that they may be separately provided and then coupled to each other so that there is no relative movement with respect to each other.

In order to improve light reception efficiency, the correction optical system 200 may exhibit a transmittance of at least 50% for a light beam of a wavelength that needs to be detected by the optical sensor module 100 among the light beams incident thereto from an exterior of the vehicle and/or a transmittance of at least 50% for a light beam of a wavelength that needs to be irradiated to the outside of the vehicle among the light beams emitted from the optical sensor module 100.

In this regard, the reasons for the optical system 200 having the transmittance of at least 50% for a light beam of a wavelength that needs to be irradiated to the outside of the vehicle among the light beams emitted from the optical sensor module 100 may be because when the optical device 1 for the vehicle according to the present disclosure is used as a lidar for detecting the position of or the distance to the object around the vehicle, the optical sensor module 100 may play a role of emitting the light for detecting the object around the vehicle as well as detecting the light returning from the outside of the vehicle.

In some embodiment, the optical device 1 may be configured such that the light transmitting through one of the correction optical system 200 or the light-transmissive member 300 may converge, while the light transmitting through the other of the correction optical system 200 or the light-transmissive member 300 may diverge. This configuration may allow the light emitted from or received by the optical sensor module 100 to propagate in parallel to the optical axis Ax of the optical sensor module 100.

Further, the correction optical system 200 and the light-transmissive member 300 may have opposite chromatic aberration patterns. This configuration may correct a chromatic aberration caused by a difference between the wavelengths of light when the light emitted from or received by the optical sensor module 100 passes through the correction optical system 200 and through the light-transmissive member 300.

The correction optical system 200 as described above may be formed in an asymmetrical manner in at least one direction with respect to the optical axis Ax of the optical sensor module 100. This is because the light-transmissive member 300 such as the windshield or the cover lens may be formed in a straight line, a curve, or a combination thereof, having a predetermined inclination angle relative to a direction perpendicular to the optical axis Ax of the optical sensor module 100, in accordance with a body contour of the vehicle. However, the present disclosure is not limited thereto. Based on a shape of the light-transmissive member 300, the correction optical system 200 may be formed in a symmetrical manner around the optical axis Ax of the optical sensor module 100.

In this regard, the optical system 200 being formed in the asymmetrical manner may be understood as that at least one of a size or a curvature thereof may be asymmetrical in at least one direction around the optical axis Ax of the optical sensor module 100.

Further, the correction optical system 200 may be formed so that an incident angle thereto of the light propagating between the optical sensor module 100 and the light-transmissive member 300 is smaller than or equal to a critical angle of total reflection. This configuration may prevent noise occurring due to light being totally reflected from the correction optical system 200.

In other words, when at least a portion of the light coming from the exterior of the vehicle is totally reflected from the correction optical system 200 or at least a portion of the light emitted from the optical sensor module 100 is totally reflected from the correction optical system 200, the noise may influence the detection result of the sensor module 100 such that the detection may become inaccurate. For this reason, the incident angle to the correction optical system 200 of the light coming from the exterior of the vehicle and the incident angle to the correction optical system 200 of the light emitted from the optical sensor module 100 may be configured smaller than or equal to 45 degrees, such that noise generation due to the total reflection is prevented or reduced.

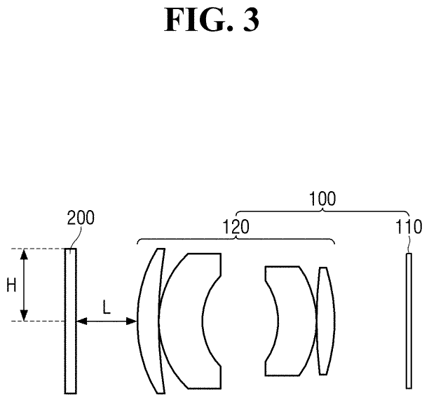

In an example, the optical sensor module 100 may have a detection range (HFOV) of at least 60 degrees or greater in one direction with respect to the optical axis Ax in order to improve detection efficiency. To this end, in an embodiment of the present disclosure, as shown in FIG. 3, where L denotes a distance between the optical sensor module 100 and the correction optical system 200, and H denotes a radius of the correction optical system 200, the ratio L/H may be equal to or less than 0.577.

The optical device 1 for the vehicle according to the present disclosure as described above may be configured such that when the light-transmissive member 300 is deformed due to an ambient temperature such that a refractive power of the light-transmissive member 300 is changed, the changed refractive power thereof may be compensated.

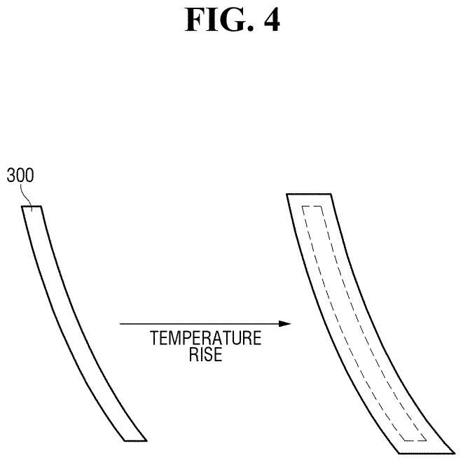

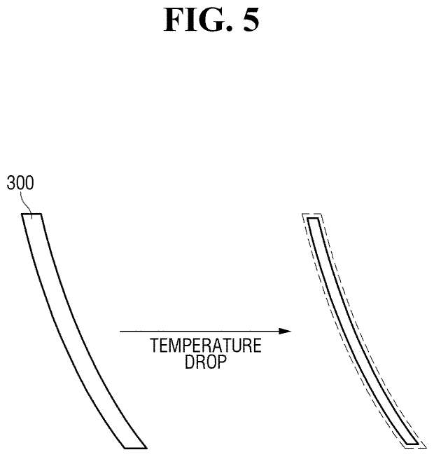

That is, when the ambient temperature increases, the light-transmissive member 300 may expand as shown in FIG. 4. Conversely, when the ambient temperature is decreased as shown in FIG. 5, the light-transmissive member 300 may contract or shrink. Accordingly, the refractive power of the light-transmissive member 300 may be changed when the light-transmissive member 300 is deformed due to the ambient temperature change. The changed refractive power thereof may be compensated using the correction optical system 200. In this regard, in FIG. 4 and FIG. 5, broken lines represent the light-transmissive member 300 before being deformed, and is intended to indicate a difference from the light-transmissive member 300 which has been deformed due to the ambient temperature.

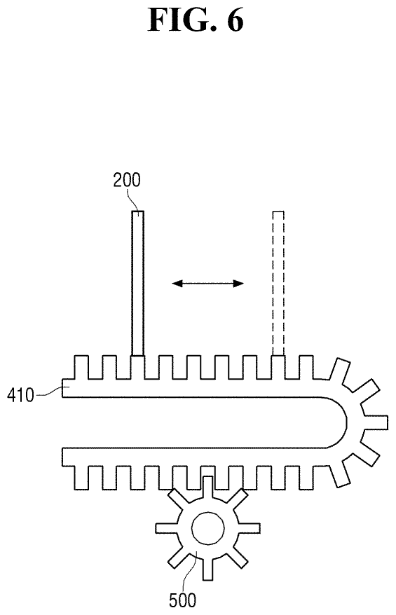

Hereinafter, a case in which the changed refractive power of the light-transmissive member 300 is compensated via the correction optical system 200 will be described in detail with reference to FIGS. 6 to 10.

FIG. 6 shows an example where the correction optical system 200 is movably installed on a rail 410, and a driver 500 operates such that the correction optical system 200 moves along the rail 410 to allow a position of the correction optical system 200 to be adjusted such that the changed refractive power of the light-transmissive member 300 may be compensated.

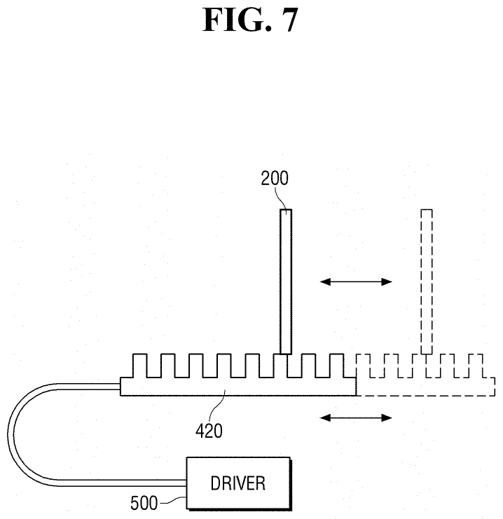

FIG. 7 shows an example where the correction optical system 200 is installed on a movable member 420, and the driver 500 operates such that the movable member 420 moves to allow the position of the correction optical system 200 to be adjusted, and thus the changed refractive power of the transmissive member 300 may be compensated.

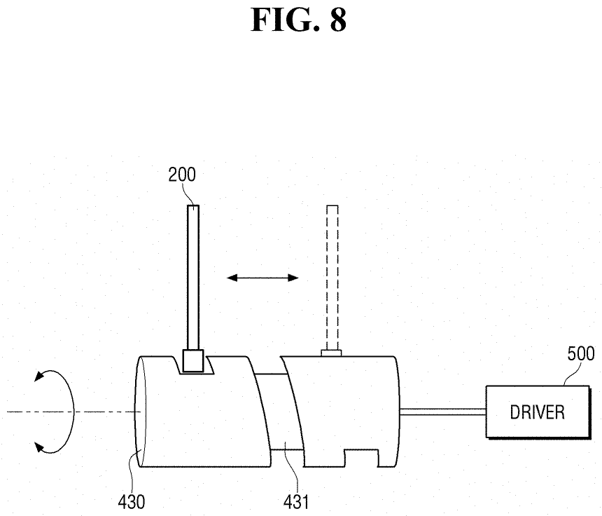

FIG. 8 shows an example where the correction optical system 200 is movably installed in a guide groove 431 formed in a rotatable member 430, and the rotatable member 430 rotates to allow the position of the correction optical system 200 to be adjusted along the guide groove 431. In other words, the guide groove 431 may extend from a first end of the rotatable member 430 toward a second end thereof along the rotation axis of the rotatable member 430 in a helical configuration around the rotation axis of the rotatable member 430. Thus, as the rotatable member 430 rotates, the correction optical system 200 may move between the first and second ends of the rotatable member 430 along the guide groove 431 to allow the position of the correction optical system 200 to be adjusted.

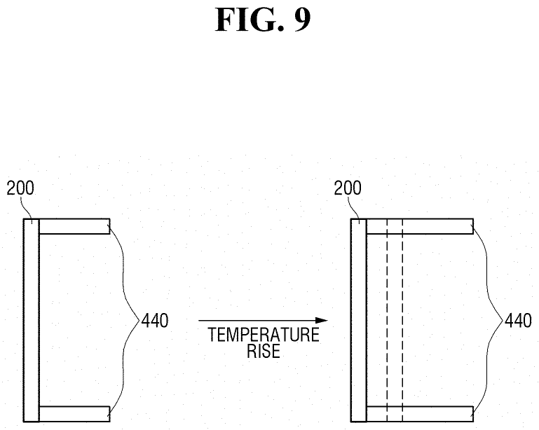

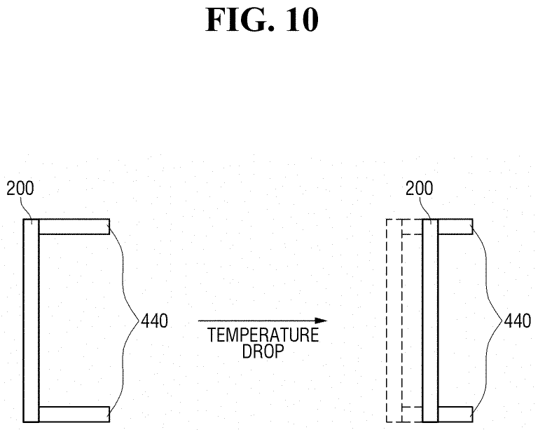

FIG. 9 and FIG. 10 are directed to an example where the correction optical system 200 is fixed to a fixing member 440 that is deformable based on the ambient temperature as the light-transmissive member 300 is. In this example, the fixing member 440 may expand as the ambient temperature increases as shown in FIG. 9 or may contract as the ambient temperature is decreased as shown in FIG. 10, to allow the position of the correction optical system 200 to be adjusted.

In the above-described FIG. 6 to FIG. 10, an example in which the correction optical system 200 linearly moves such that the position thereof is adjusted has been described. However, the present disclosure is not limited thereto, and a position of the correction optical system 200 may be adjusted linearly, rotationally, or by any combination thereof.

Further, a structure for adjusting the position of the correction optical system 200 is not limited to the above examples. Various structures for adjusting the position of the correction optical system 200 based on the ambient temperature change may be used.

Further, in the above-described FIGS. 6 to 10, an example in which the position of the correction optical system 200 is adjusted so that the changed refractive power of the light-transmissive member 300 is compensated has been described. The present disclosure is not limited thereto, however. The correction optical system 200 may be made of a resin material that may be deformed based on the ambient temperature, similar to the light-transmissive member 300. When the light-transmissive member 300 expands or contracts, the correction optical system 200 may also expand or contract so that the changed refractive power of the light-transmissive member 300 may be compensated.

In the above-described embodiments, an example in which the position of the correction optical system 200 is adjusted based on the ambient temperature change or the correction optical system 200 is deformed based on the ambient temperature change, so that the refractive power of the light-transmissive member 300 that has changed due to the deformation of the light-transmissive member 300 is compensated has been described. However, the present disclosure is not limited thereto. The position of the correction optical system 200 may remain fixed while a constant temperature range is maintained actively based on the ambient temperature measurement using a temperature sensor.

For example, the ambient temperature may be sensed using the temperature sensor, and a heater or a cooling fan may be activated based on the detected ambient temperature to maintain the temperature of the system in a substantially constant temperature range. As such, the position of the correction optical system 200 may remain fixed.

In the above-described embodiment, a case where the optical device 1 for the vehicle according to the present disclosure serves to receive the light entering from the exterior of the vehicle has been described by way of example. The present disclosure is not limited thereto, however. When the optical device 1 for the vehicle according to the present disclosure is used as a lidar for detecting the position of or the distance to the object around the vehicle, the device 1 may have a light emitting function as well as a light receiving function.

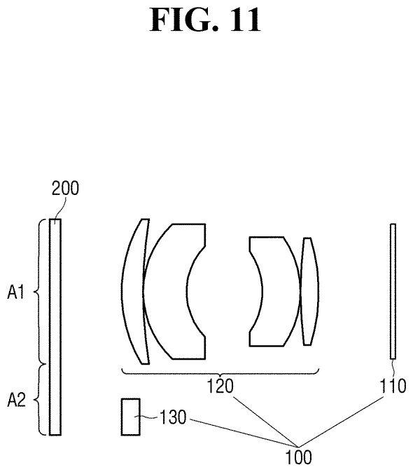

FIG. 11 is a schematic diagram showing a configuration of an optical device for a vehicle according to another embodiment of the present disclosure. Referring to FIG. 11, an optical device 1 for a vehicle according to another embodiment of the present disclosure may include the optical sensor module 100 and the correction optical system 200 in a similar manner to the above-described embodiment.

In another embodiment of the present disclosure, the optical sensor module 100 may include not only a light receiving function but also a light emitting function. To this end, the optical sensor module 100 may further include a light-emitting module 130 in addition to the light-receiving sensor 110 and the at least one optical element 120.

For example, the light-emitting module 130 may generate light such as a pulse laser. The light generated from the light-emitting module 130 may be reflected from the object around the vehicle and may be received by the light-receiving sensor 110. In this regard, the light emitted from the light-emitting module 130 may be refracted by the light-transmissive member 300 such that the propagation direction of the light may change, as the light coming from the outside of the vehicle may. When the propagation direction of the light is changed by the light-transmissive member 300, the measuring accuracy of the position of or the distance to the object around the vehicle may decrease, thereby increasing a risk of a vehicle accident.

Therefore, in another embodiment of the present disclosure, the correction optical system 200 may refract the light emitted from the light-emitting module 130 in a direction different from a direction in which the light-transmissive member 300 refracts the light, such that the light emitted from the light-emitting module 130 propagates in a parallel manner to the optical axis Ax of the optical device 1 for the vehicle according to the present disclosure. Thus, accurate detection of the position and/or the distance to the object around the vehicle may be achieved.

To this end, the correction optical system 200 may be divided into a first area A1 for correcting the propagation direction of the light propagating to the light-receiving sensor 110 and a second area A2 for correcting the propagation direction of the light emitted from the light-emitting module 130. Accordingly, both the propagation direction of the light received by the light-receiving sensor 110 and the propagation direction of the light emitted from the light-emitting module 130 may be corrected.

In another embodiment of the present disclosure, an example in which a single correction optical system 200 is used to correct the propagation direction of the light coming from the exterior of the vehicle and the propagation direction of the light emitted from the light-emitting module 130 is described. The present disclosure is not limited thereto, and the correction optical system 200 may have separate optical members respectively to correct the propagation direction of the light coming from the exterior of the vehicle and the propagation direction of the light emitted from the light-emitting module 130.

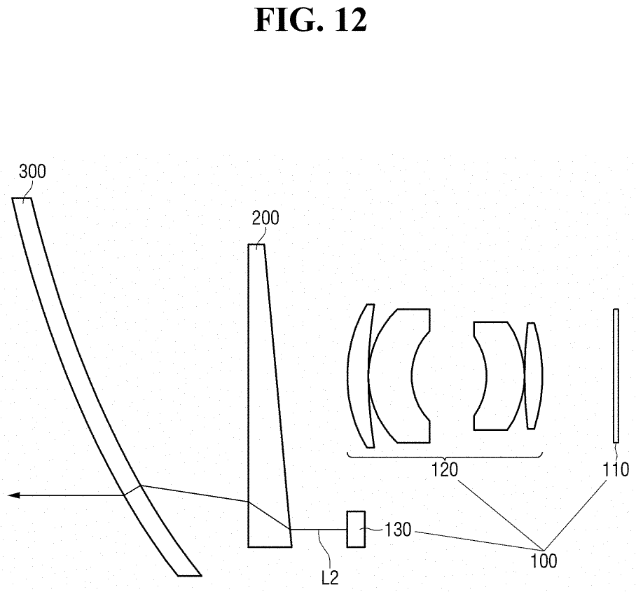

FIG. 12 is a schematic diagram showing a propagation direction of the light emitted from an optical device for a vehicle according to another embodiment of the present disclosure. Referring to FIG. 12, light L2 emitted from the light-emitting module 130 of the optical sensor module 100 according to another embodiment of the present disclosure may be refracted by the correction optical system 200 in a direction different from a direction in which the light L2 is refracted by the light-transmissive member 300, such that the light L2 may propagate parallel to the optical axis Ax of the optical device 1 for the vehicle according to the present disclosure.

In this regard, FIG. 12 illustrates a case in which the correction optical system 200 refracts the light emitted from the light-emitting module 130 in the direction opposite to the direction in which the light is refracted by the light-transmissive member 300. The present disclosure is not limited thereto, however. The correction optical system 200 may refract the light emitted from the light-emitting module 130 in the same side in which the light is refracted by the light-transmissive member 300 such that a refraction angle by which the correction optical system 200 refracts the light may be varied based on the position of the optical device 1 for the vehicle according to the present disclosure.

As described above, in the optical device 1 for the vehicle according to the present disclosure, when the light emitted from or received by the optical sensor module 100 is refracted by the light-transmissive member 300 disposed in front of the optical sensor module 100, the propagation direction thereof may be changed. The changed propagation direction of the light may be corrected via the correction optical system 200. Thus, the sensing accuracy may be improved, and thus, a possibility of a vehicle accident may be greatly reduced.

A person of ordinary skill in the technical field to which the present disclosure belongs will be able to understand that the present disclosure may be implemented in other forms without changing the technical spirit or essential characteristics thereof. Therefore, the embodiments as described above should be understood as not limiting but illustrative in all respects. All changes or modifications derived from the meaning and scope of the claims and their equivalent concepts should be interpreted to be included in the scope of the present disclosure.

What is claimed is:

1. An optical device for a vehicle, comprising:
an optical sensor module for detecting light that propagates through a light-transmissive member and toward the optical sensor module; and
a correction optical system which includes at least one optical member to refract the light that propagates between the light-transmissive member and the optical sensor module in a direction different from a direction in which the light-transmissive member refracts the light.

2. The optical device of claim 1, wherein the optical sensor module includes at least one of a camera or a lidar.

3. The optical device of claim 1, wherein the at least one optical member is formed in an asymmetric configuration in at least one direction around an optical axis of the optical sensor module.

4. The optical device of claim 1, wherein one of the correction optical system or the light-transmissive member allows light that transmits therethrough to converge, while the other thereof allows light that transmits therethrough to diverge.

5. The optical device of claim 1, wherein the correction optical system refracts the light in a direction opposite to the direction in which the light-transmissive member refracts the light.

6. The optical device of claim 1, wherein in response to the light-transmissive member being deformed due to an ambient temperature change such that a refractive power of the light-transmissive member is changed, the correction optical system compensates for the changed refractive power of the light-transmissive member.

7. The optical device of claim 6, wherein the correction optical system is configured such that the at least one optical member is deformed based on the ambient temperature change so as to compensate for the changed refractive power of the light-transmissive member.

8. The optical device of claim 6, wherein the correction optical system is configured such that a position of the at least one optical member is adjusted based on the ambient temperature change so as to compensate for the changed refractive power of the light-transmissive member.

9. The optical device of claim 8, wherein the position of the at least one optical member is adjusted linearly, rotationally, or by any combination thereof.

10. The optical device of claim 6, wherein the correction optical system is configured such that the at least one optical member is fixed to a fixing member that is deformable based on the ambient temperature change, and
wherein in response to the fixing member being deformed, a position of the at least one optical member is adjusted to compensate for the changed refractive power of the light-transmissive member.

11. The optical device of claim 1, wherein the optical sensor module further includes a light-emitting module for emitting light toward the light-transmissive member, and
wherein the correction optical system refracts the light emitted from the light-emitting module in a direction different from a direction in which the light-transmissive member refracts the light emitted from the light-emitting module.

12. The optical device of claim 11, wherein the correction optical system refracts the light emitted from the light-emitting module in a direction opposite to the direction in which the light-transmissive member refracts the light emitted from the light-emitting module.

13. The optical device of claim 11, wherein the correction optical system comprises a first area for refracting light that transmits through the light-transmissive member and propagates toward the optical sensor module, and a second area for refracting the light that is emitted from the light-emitting module and propagates toward the light-transmissive member.

14. The optical device of claim 1, wherein the at least one optical member includes at least one of a lens, a mirror, or a prism.

15. The optical device of claim 1, wherein the light-transmissive member and the correction optical system have opposite chromatic aberration patterns.

16. The optical device of claim 1, wherein the correction optical system has a transmittance of at least 50% for a light beam of a wavelength required to be detected by the optical sensor module among light beams incident thereto from an exterior of the vehicle and/or a transmittance of at least 50% for a light beam of a wavelength required to be irradiated to the exterior of the vehicle among light beams emitted from the optical sensor module.
